(19) United States
(12) Patent Application Publication
(10) Pub. No.: US 2011/0137811 A1
(43) Pub. Date: Jun. 9, 2011

(54) NETWORK BASED REAL ESTATE TRANSACTION PORTAL SYSTEM AND METHOD

(75) Inventors: Chintan Niranjan PATEL, Lakeworth, FL (US); Niranjankumar Vasudev PATEL, Lake Worth, FL (US)

(73) Assignee: CN SOFTNET INC., Lake Worth, FL (US)

(21) Appl. No.: 12/959,039

(22) Filed: Dec. 2, 2010

Related U.S. Application Data
(60) Provisional application No. 61/267,395, filed on Dec. 7, 2009.

(51) Int. Cl. G06Q 50/00

(52) U.S. Cl. 705/313

(57) ABSTRACT

According to one aspect, the invention provides a data processing system that includes a memory and a processor. The memory stores information concerning real estate, buyers, sellers and third party service providers. The information includes a buyer profile and at least one searchable buyer request that includes property-related buyer preferences; a seller profile and at least one searchable seller listing that includes information about a property; and a service provider profile and at least one searchable real estate-related service. The processor accesses and provides information in response to one or more queries from one of a buyer, a seller, or a 3^{rd} party service provider.

### CROSS-REFERENCE TO RELATED APPLICATION

This application is related to and claims priority to U.S. Provisional Patent Application Ser. No. 61/267,395, filed Dec. 7, 2009, entitled ONLINE PORTAL FOR REAL ESTATE TRANSACTIONS AND INFORMATION BASED RUNNING ON A COMPUTER NETWORK, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for sharing real estate information, and more particularly to a network-based method and system for sharing real estate information among buyers, sellers and third party service providers.

### BACKGROUND OF THE INVENTION

Online real estate websites generally provide a buyer a way to search listings of residential and commercial real estate. Typically, a sellers' agent or an independent organization, such as the Multiple Listing Service (MLS), hosts the website and is responsible for updating the information available via the website. The information may include a location, price, price history, price per square foot, number of rooms, types of rooms, a lot size, year built, square footage of living or office space, and prices of similar properties near the location. The website may enable a buyer to search by the same criteria that is provided for each item of real estate. Thus, for example, a buyer may be able to specify a price range, an earliest year built, and a minimum square footage. A database management engine of the website may then search for properties satisfying the specified search criteria. The website may also provide a map showing a location of a property and its surrounding features, such as schools, grocery stores, etc. The website may also allow a buyer to request a showing of a property.

A problem with existing real estate information websites is that the amount of information available to buyers and sellers is limited. A buyer is typically not able to research different sellers at a single website. For example, a buyer may want to search for all sellers having at least 10 years of experience, or all sellers with no more than 5 employees. Further, a seller may want to monitor which buyers have recently visited one or more listings of the seller. Further, a seller may want to search among a pool of buyers, based on buyers' expressed preferences. Further, a buyer or seller may want to search different third party service providers that provide real estate related services, such as real estate lawyers, construction companies, interior designers, and mortgage companies. Such information and functionality is not available in current systems. Accordingly, there is a need for a real estate website that is more informative and flexible than real estate websites that are currently available.

### SUMMARY OF THE INVENTION

The present invention advantageously provides a method and system to share real estate information. According to one aspect, the invention provides a data processing system that includes a memory and a processor. The memory stores information concerning real estate, buyers, sellers and third party service providers. The information includes a buyer profile and at least one searchable buyer request that includes property-related buyer preferences. The information also includes a seller profile and at least one searchable seller listing that includes information about a property. The information also includes a service provider profile and at least one searchable real estate-related service. The processor accesses the memory and provides information in response to a search query from one of a buyer, seller, or third party service provider. The search query directs the processor to search at least one of the at least one searchable buyer request, the at least one searchable seller listing, and the at least one searchable real estate related service to provide responsive information corresponding thereto.

According to another aspect, the invention provides a method of sharing real estate information via a web portal database system. The method includes providing webpages to receive profile information concerning a participating member of the web portal database system, the participating member being one of a real estate buyer, a real estate seller, and a third party service provider. The method includes providing a member dashboard webpage that provides access to mail, new visitors, member ratings, and recent member activity. The method also includes providing a webpage to receive a searchable request from a buyer, the buyer request including buyer real estate preferences. The method also includes providing a webpage to receive a searchable listing by a seller, the seller listing including property attributes. The method also includes providing a webpage to receive seller-initiated searches of the buyer requests. Also provided are webpages to receive buyer-initiated searches of the seller listings, and to receive buyer and seller initiated searches of 3^{rd} party service provider services.

According to another aspect, the invention provides a computer readable tangible medium containing instructions that when executed by a computer, cause the computer to perform operations for sharing real estate information. The operations include receiving information from a plurality of members that include real estate buyers, sellers and third party service providers. The operations further include presenting requests from buyers, the buyer requests including location information, financial information, and property type. The operations also include presenting listings of sellers, the seller listings including location information, financial information, and property type. Also, the operations include presenting information of third party service providers, receiving member requests for information of other members, and providing requested information to a requesting member.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary real estate data processing system constructed in accordance with the principles of the present invention;

FIG. 2 is a diagram of exemplary webpages that may be produced according to an embodiment of the invention;

FIG. 3 is a flow chart of an exemplary process for accessing information from a dashboard of a member;

FIG. 4 is a flow chart of an exemplary process for creating a request (of a buyer) or listing (of a seller);

FIG. 5 is a flow chart of an exemplary process for creating a third party service provider profile; and

FIG. 6 is a flow chart of an exemplary process of creating and conducting a search.

### DETAILED DESCRIPTION OF THE INVENTION

Before describing in detail exemplary embodiments that are in accordance with the present invention, it is noted that the embodiments reside primarily in combinations of apparatus components and processing steps related to implementing a real estate information website. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

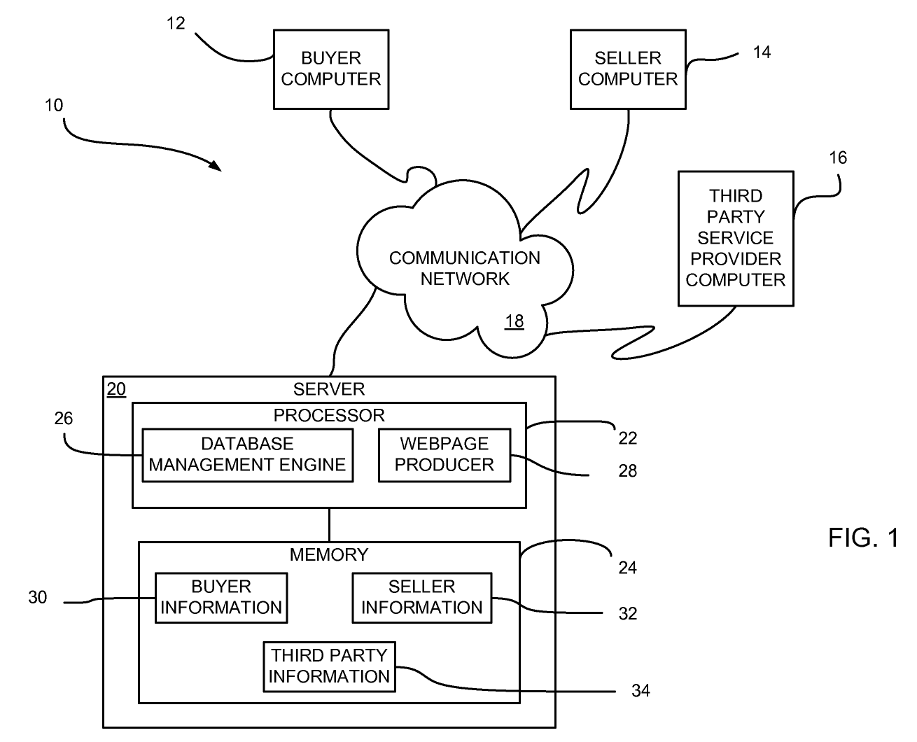

Referring now to the drawing figures in which like reference designators refer to like elements, there is shown in FIG. 1 a block diagram of an exemplary real estate data processing system constructed in accordance with the principles of the present invention, and designated generally as “10”. The real estate data processing system 10 includes a buyer computer 12, a seller computer 14, a third party service provider computer 16, a communication network 18, and a server 20. The buyer computer 12, the seller computer, 14, and the third party service provider computer 16 can each communicate with each other and with the server 20 via the communication network 18. The computers 12, 14, and 16, may include desktop devices, laptops, or mobile wireless devices. The communication network 18 may include the Internet, the Public Switched Telephone Network, a cable network, an optical network, a wireless network, a combination thereof, as well as other network technologies.

The server 20 may be located at a central location and may be hosted by a real estate agent or third party provider. As used herein, a real estate agent may be referred to as a “seller” when acting as an agent for a seller, and may be referred to as a “buyer” when acting as an agent for a buyer. Also, as used herein, a third party service provider refers to a third party other than a buyer or seller, such as a law firm, a construction company, an interior decorator, a mortgage company, etc. The server 20 may include a processor 22 in communication with a memory 24. The processor 22 may perform functions of a database management engine 26 and a webpage producer 28. The memory 24 may include buyer information 30, seller information 32, and third party service provider information 34 and may store the database and programmatic code used to perform the functions described herein. The information 30, 32, and 34 may be searched by the database management engine 26, based on search queries entered by a user of one of the computers 12, 14, and 16, and the results of a search may be presented by the webpage producer 28. The server may also include communication devices and input/output interfaces (not shown) as known in the art to facilitate communication with other system elements via the network 18.

Thus, one embodiment is a data processing system that includes a memory 24 and a processor 22. The memory stores information concerning real estate, buyers, sellers and 3^{rd} party service providers in the database management engine 26. Databases, such as SQL databases, are known and are beyond the scope of the present invention. The buyer information 30 includes a buyer profile for each buyer and at least one searchable buyer request that includes property-related buyer preferences. The seller information 32 includes a seller profile for each seller and at least one searchable seller listing that includes information about a property. The third party information 34 includes a service provider profile and at least one searchable real estate-related service. The processor 22 accesses and provides the information 30, 32, and 34, in response to one or more queries of a buyer, seller or 3^{rd} party service provider.

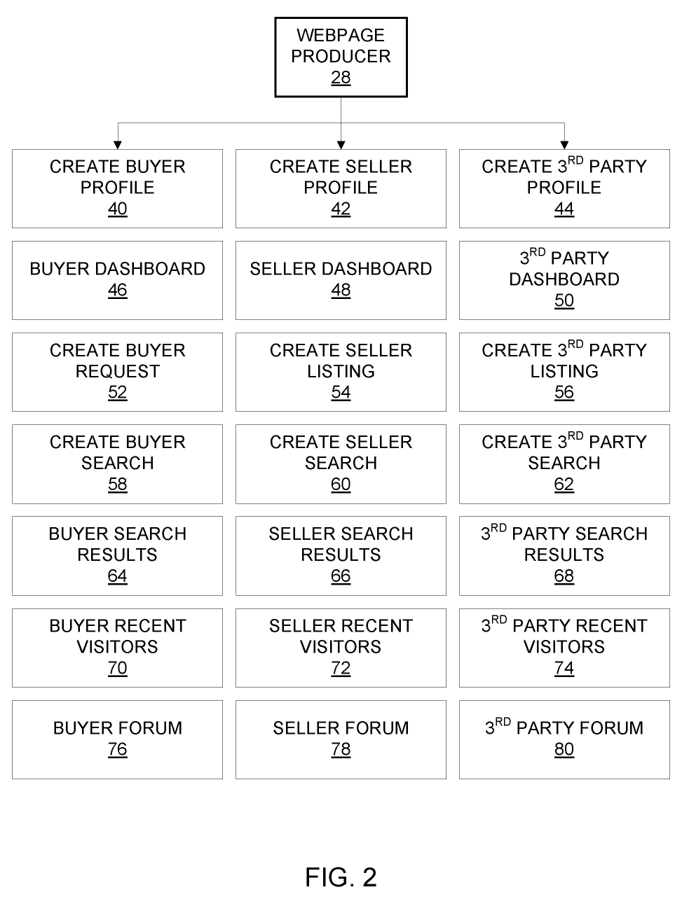

FIG. 2 shows a plurality of webpages 40-80 that may be produced by the webpage producer 28. Generally, the webpages may be classified as serving either the buyer (webpages 40, 46, 52, 58, 64, and 70), the seller (webpages 42, 48, 54, 60, 66, and 72), or a third party service provider (webpages 44, 50, 56, 62, 68, and 74). Different embodiments may have some or all of the webpages shown in FIG. 2, as well as webpages not shown. For example, the webpage producer 28 may produce a webpage 40 that enables a buyer to create a profile. The “create buyer profile” page 40 may include entries that enable a buyer to provide his or her contact information, occupation, industry, education, organizations, social media links as well as pictures and videos. Similarly, webpages 42 and 44 enable a seller and a third party service provider, respectively, to provide similar information. In addition, seller or 3^{rd} party provider service provider information may include number of employees, other office locations, years in business, specialties and services provided.

Webpages 46, 48, and 50 present dashboards for the buyer, seller, and 3^{rd} party provider respectively. A dashboard may include a display that enables immediate access to new information obtained since the member has last looked at the information provided by the dashboard. For example, the dashboard may provide quick access to new mail, new feedback, new visitors, recent searches, saved properties, saved requests, saved service providers, saved profiles, and new profile activity. Also, the dashboard provides a button to select to edit the dashboard or to edit notifications. For example, a member may change whether to be notified of an event by way of email, text, phone, video alert, etc. New mail may be from other members. New feedback may be ratings of the member entered by other members. The ratings may be a percentage of 100, one or more of five stars, or other rating system. In some embodiments, a member may exclude his or her rating from being displayed to others by the system 10. New visitors may be a list of visitors that have visited a buyer's request, a seller's listing, or a 3^{rd} party's profile_since the last time the member checked its new visitors. New profile activity may include a list of changes made to a member's profile. Other information may also be included in a dashboard.

Webpages 52, 54, and 56 enable a member to create a request (in the case of a buyer), a listing (in the case of a seller) and a profile, (in the case of a 3^{rd} party service provider.) For example, webpage 52 enables a buyer to specify characteristics of a property the buyer may be interested in purchasing or leasing. The buyer request may include a property type, a price range, a number of units, a number of acres, a range of net operating income (NOI), capitalization (Cap) rate, estimated time until transaction, an alert message preference, a video, a location, mileage to specific destinations (such as hospitals, turnpikes, free ways, parks, beaches, lakes, restaurants, schools, etc). Thus, in one embodiment, a list of feature names is provided along with a window to enter a mileage range restricting locations to be within a specified range of a named feature. The request may also include a link to a video provided by the buyer. Property types that may be specified by the buyer may include foreclosure, express sale, franchise property, 1041 exchanges, auction property, pre-listing, and short sale.

The webpage 54 enables a seller to specify characteristics of a property the seller is interested in selling or leasing. The seller listing may include room measurements, room descriptions, property type, commercial category, financial documents, NOI, Cap rate, profit and loss statements, franchise information, video tour of the property as well as other features including a map to the property and to nearby locations such as free ways, turnpikes, restaurants, hospitals, airports, colleges, beaches, convention centers, etc. Next to the map, the distance from the listed property and the nearby locations may be given, rounded off to the nearest mile, for example. In one embodiment, the listing includes a list of feature names and when a member, such as a buyer, moves a cursor over the feature name, the named feature is located on the map by a pinpoint and the distance from the listed property to the named feature is displayed. Multiple features may be shown on the map.

The webpage 56 enables a 3^{rd} party service provider to specify characteristics of the service provider, in addition to information provided in the 3^{rd} party service provider's basic profile. For example, a 3^{rd} party service provider profile may include mortgage rates, construction services, interior design information, map to office locations, etc., as well as years of experience, years in business, multiple contact information, description of services, an uploaded logo, photograph or video or audio recording, a number of employees, an industry type, etc.

Webpages 58, 60 and 62 enable a member to create a search. For example, webpage 58 enables a buyer to enter search criteria to search the listings of sellers and 3^{rd} party service providers. For example, the search criteria entered by the buyer may include price range, miles from a destination such as a hospital, NOI range, Cap rate range, type of property (including foreclosure, express sale, franchise, 1041 exchanges, auction, pre-listing, short sale), and estimated time range of transaction completion. And/or the webpage 58 may include, for a search of 3^{rd} party service providers, firm size, years of experience, locations (for example, within X miles of location Y), rates, prices, industry type, contacts, etc. Webpage 60 enables a seller to search buyers and buyer requests, based on search criteria that may include, price range, type of property, age of buyer, credit rating of buyer, a number of units, a number of acres, NOI, Cap rate, etc. Webpage 60 may also enable the seller to search 3^{rd} party service providers. Webpage 62 may be similar to webpages 58 and 60 to enable a 3^{rd} party service provider to search buyers' requests and sellers' listings. Note that in one embodiment, buyers may not search other buyers or buyer requests. Webpages 64, 66, and 68 display the results of searches initiated by buyers, sellers and 3^{rd} party service providers respectively. In addition, an icon may be provided that, if selected by the member, will provide other requests or listings of the buyer or seller, respectively.

Thus, buyers may search seller profiles, seller listings, and third party service provider profiles. Sellers may search buyer profiles, buyer requests, other sellers' listings and other sellers' profiles, and third party service provider profiles. Third party service providers may search buyer profiles and buyer requests, seller profiles and seller listings, and other third party service providers' profiles.

Webpage 70 provides a list of members who recently visited a request of a buyer, and the identity of the visited request. The list may include the request visited, a last login time and date of the visitor and/or the date and time of the visit. Webpage 72 provides a list of members who recently visited a listing of a seller, the name of the visited listing, the time and date of the visit, and/or the time and date of the visitor's last login. Similarly, webpage 74 provides a list of visitors to a 3^{rd} party provider's profile

Webpages 76, 78, and 80 may provide chat forums with lists of hot topics for buyers, sellers, and 3^{rd} party service providers, respectfully. In some embodiments, each forum is open to all other members so that, for example, a buyer may participate in a chat with a seller in the seller's forum. Further, a chat room or forum may enable a member to immediately upload a photo or video, and may enable the member to choose to receive notifications when a response to a question or comment by the member is received. The notification may be one or more of email alert, text alert, phone alert, or video alert, etc.

Thus, some embodiments include a method of sharing real estate information via a web portal database system. The method includes providing webpages to receive profile information concerning a participating member of the web portal database system, the participating member being one of a real estate buyer, a real estate seller, and a third party service provider. The method also includes providing a member dashboard webpage that provides access to mail, new visitors, member ratings, and recent member activity, including recent searches, and recent profile changes. The dashboard may be edited to highlight or post other features, change color schemes, upload a logo, etc. The method also includes providing a webpage to receive a request from a buyer, the buyer request including buyer real estate preferences, and providing a webpage to receive a listing by a seller, the seller listing including property attributes. The method may also include providing a webpage to receive an enhanced third party service provider profile that includes information that is in addition to a basic third party service provider profile. The enhanced third party service provider profile may include year in business, a number of employees, multiple locations, multiple contacts, an uploaded logo, photo, video or audio recording, a description of services, a type of industry, etc. The method also includes providing a webpage to receive seller-initiated or third party service provider-initiated searches of the buyer requests, providing a webpage to receive buyer-initiated, seller initiated, or third party service provider-initiated searches of the seller listings, and providing a webpage to receive buyer-initiated, seller-initiated, or third party service provider-initiated searches of 3^{rd} party service provider profiles.

In some embodiments, one or more webpages provide a last login time and date of a buyer, seller or 3^{rd} party service provider. Also, in some embodiments, a webpage provides a list and a link to the profile of each buyer who visits a seller or 3^{rd} party provider listing. In some embodiments, a webpage provides to a buyer a list and a link to a profile of each seller or 3^{rd} party service provider that visits a request of the buyer. In some embodiments, a webpage provides to a third party service provider a list and a link to a profile of each seller or buyer that visits a profile of the 3^{rd} party service provider.

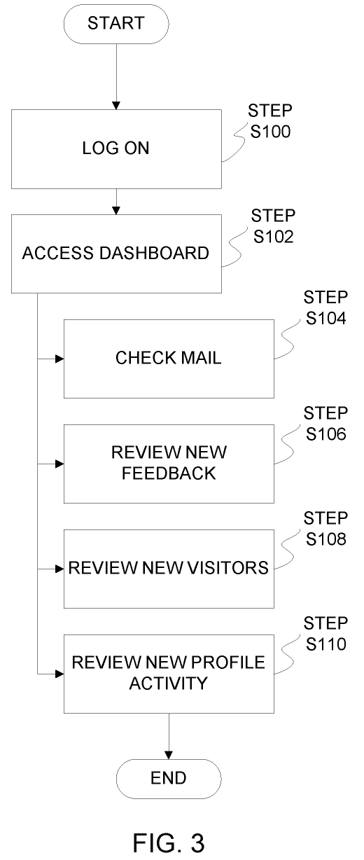

FIG. 3 is a flow chart of an exemplary process for accessing information from a dashboard of a member. An already-registered member initially logs on to the system (step S100). After logging on, the member will first be presented with his or her dashboard, (step S102). From the dashboard, the member may check mail, (step S104), review new feedback, (step S106), review new visitors (step S108), and review new profile activity (step S110). In some embodiments, any or all of these steps may be performed in any order. Other features described herein may be accessed by the dashboard. The dashboard is customizable by a member.

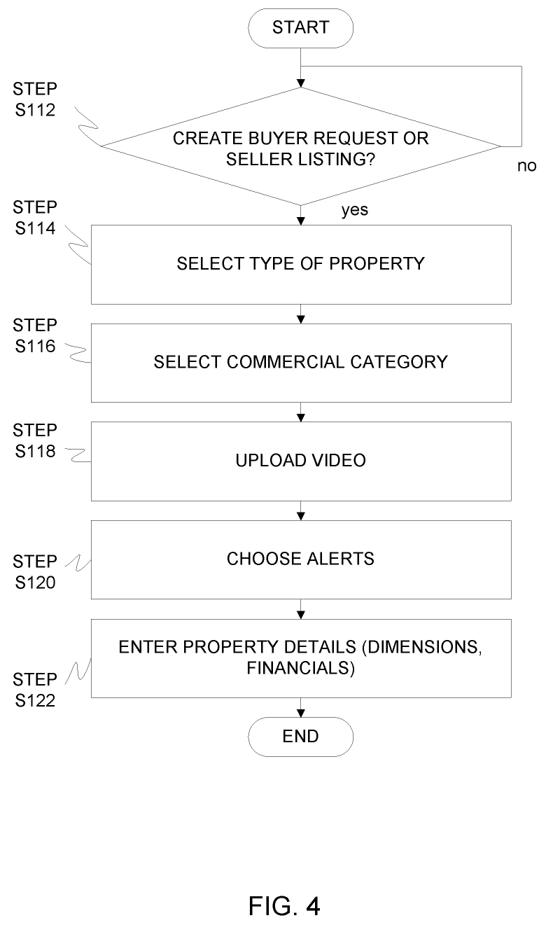

FIG. 4 is a flow chart of an exemplary process for creating a request (of a buyer) or listing (of a seller). First, the member is given an opportunity to initiate the creation of a request or listing, (step S112). The member selects a type of property, (step S114). The member may also select a commercial category, (step S116). A commercial category may include, office, industrial, food outlet, land, assisted living, home, condominium, shopping center, health and fitness, retail, sports, etc., (step S116). The member may be given the opportunity to upload a video or photo, (step S118). Next, the member may be given the option to select what type of alert to receive when a visitor visits the request or listing, (step S120). An alert type may include email, text, or phone, or video alert. For example, a member may choose to be alerted by email when someone saves a property listing or request of the member. The email may be sent externally to a email program of a member computer, or internally within a webpage of the web server 20.

Next, the member may enter property details such as dimensions, financial information, etc., (step S122). Once the member completes the request or listing, the request or listing may be searched. Other information not shown in FIG. 4 may be included in a buyer's request or a seller's listing.

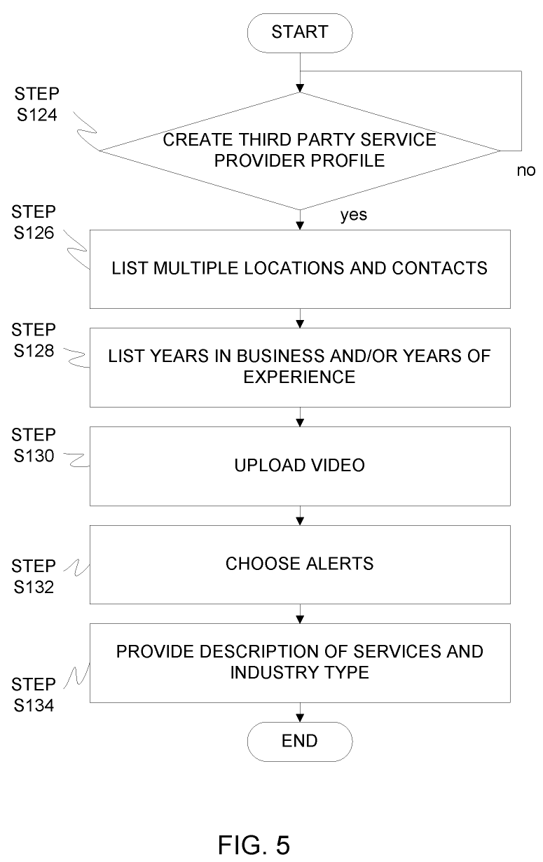

FIG. 5 is a flow chart of an exemplary process for creating a third party service provider profile. First, the 3^{rd} party service provider is given the opportunity to create a profile. In one embodiment, a third party service provider is given the opportunity to create an initial profile when first joining the system. Then, the third party service provider is given the opportunity to create an enhanced or more detailed profile, at step S124. For example, the provider may list multiple office locations and multiple contacts, at step S126. The provider may also list year of experience or years in business, at step S128. The provider may also upload a logo, or video, or photo, or audio recording, at step S130. The provider may also choose how to be alerted of an event, at step S132. Such an event may include a buyer visiting the provider's profile, for example. A type of alert may include email, text, phone, video or audio alert. Also, the 3^{rd} party provider may provide a description of services offered and an industry type to which the provider belongs, at step S134. Other information not shown in FIG. 5 may be included in the profile.

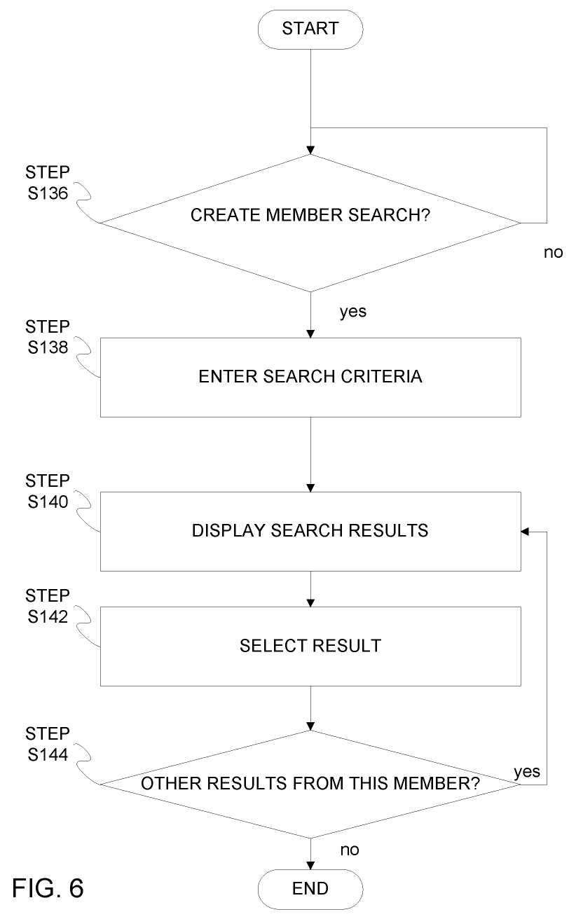

FIG. 6 is a flow chart of an exemplary process of creating and conducting a search. First, the member is given the opportunity to initiate a search, (step S136). The member then enters search criteria, (step S138), which may include, price and other financial information, lot size, number of rooms, square foot, price per square foot, year built, type of property, etc. Then, after selecting the search button, the search results are displayed, (step S140). From the search results the searching member may select a particular result, (step S142). The member may also be given the option to select other results from a member, (step S144).

In some embodiments, a number of times buyers express an interest in a particular listing or a particular seller or a particular service provider is tabulated and provided to a member. Other statistics may be tabulated and displayed as well. For example, the processor 22 may determine a rate at which a listing or request is visited (e.g., number of hits per hour), a rate at which a particular property type is searched, a number of properties having a specified NOI or Cap rate, etc. Also, in some embodiments, when a buyer expresses an interest in a listing, by for example, clicking on an icon, a pop-up window appears with a customizable message that the buyer may send to the seller who listed the listing.

In some embodiments, a member may toggle between a presentation of only residential real estate and a presentation of only commercial real estate. In some embodiments, a member may toggle between a website as described herein and a website hosted by a fourth party. For example, a website as described herein may provide only commercial real estate information, whereas the fourth party website may include only residential real estate. Thus, a member viewing a residential real estate listing matching certain location criteria may toggle to view a commercial listing matching the location criteria. Also, in some embodiments, a member can exclude data of the member from searches. In some embodiments, one member may be able to rate other members

One embodiment is a computer readable tangible medium, containing instructions that when executed by a computer, cause the computer to perform operations for sharing real estate information. The operations include receiving information from a plurality of members that include real estate buyers, sellers and third party service providers. The operations further include presenting requests from buyers, the buyer requests including location information, financial information, and property type. The operations also include presenting listings of sellers, the seller listings including location information, financial information, and property type. The operations also include presenting information of third party service providers, receiving member requests for information of other members, and providing requested information to a requesting member. The third party provider information may include at least one of a number of years of experience, a number of employees, and office locations.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A real estate data processing system, comprising:
a memory, the memory storing information relating to real estate, buyers, sellers, and third party service providers, the information comprising:
a buyer profile and at least one searchable buyer request that includes property-related buyer preferences;
a seller profile and at least one searchable seller listing that includes information about a property;
a service provider profile and at least one searchable real estate-related service; and
a processor in communication with the memory, the processor:
accessing the memory and providing information in response to a search query from one of a buyer, seller, or third party service provider, the search query directing the processor to search at least one of the at least one searchable buyer request, the at least one searchable seller listing, and the at least one searchable real estate related service to provide responsive information corresponding thereto.

2. The system of claim 1, wherein the processor further operates to:
generate a webpage that receives a request entered by a buyer, the request including includes a type of property requested, an NOI and a Cap rate, the type of property requested being at least one of a foreclosure, an express sale, a franchise, a 1401 exchange, an auction property, a pre-listing, and a short sale.

3. The system of claim 1, wherein the processor further operates to:
generate a webpage to receive a request entered by a buyer, the request including a link to a video provided by the buyer.

4. The system of claim 1, wherein the processor further operates to:
generate a webpage to receive a request entered by a buyer, the request including a location of interest to the buyer, the webpage showing a map of the location, and further providing a list of feature names and a distance of a feature to the location.

5. The system of claim 4, wherein the features include at least one of a freeway, a turnpike, a restaurant, a hospital, an airport, a university, a beach, a park, and a convention center.

6. The system of claim 4, wherein a feature is identified on the map and the distance of the feature to the location is provided when a graphical user interface cursor is located over a name of the feature.

7. The system of claim 1, wherein the processor further operates to:
execute a seller-initiated search of property requests entered by one or more buyers, wherein specified search criteria includes a type of property requested, a NOI range and a Cap rate range.

8. The system of claim 1, wherein the processor further:
provides a webpage to receive a listing entered by a seller that includes an NOI and a CAP rate.

9. A method of sharing real estate information via a web portal database system, the method comprising:
providing a webpage to receive profile information relation to a participating member of the web portal database system, the participating member being one of a real estate buyer, a real estate seller, and a third party service provider;
providing a member dashboard webpage that provides access to mail, new visitors, member ratings, and recent member activity;
providing a webpage to receive a searchable request from a buyer, the buyer request including buyer real estate preferences;
providing a webpage to receive a searchable listing by a seller, the seller listing including property attributes;
providing a webpage to receive seller-initiated searches of the buyer requests;
providing a webpage to receive buyer-initiated searches of the seller listings; and
providing a webpage to receive buyer and seller initiated searches of 3^{rd} party service provider services.

10. The method of claim 9, wherein a web page provides a last login time and date of a buyer.

11. The method of claim 9, wherein a number of times buyers express interest in a listing of a seller is tabulated and provided to the seller.

12. The method of claim 9, further comprising providing a seller with a list and a profile of each member who visits a listing of the seller.

13. The method of claim 9, further comprising providing a member with a list and a profile of each member who views a service provider profile.

14. The method of claim 9, further comprising providing a buyer with list and a profile of each seller and third party service provider who reviews a request of the buyer.

15. The method of claim 9, wherein a buyer-initiated search specifies at least one buyer preference that includes a type of property, a location, and financial information that includes at least one of a profit and loss statement, a cash flow, an NOI range and a CAP rate range

16. The method of claim 9, further providing a toggle function to toggle between displaying subject matter concerning commercial real estate and subject matter concerning residential real estate.

17. The method of claim 9, wherein a listing provides a link to financial documents related to a property.

18. A computer readable tangible medium, containing instructions that when executed by a computer, cause the computer to perform operations, the operations including:
receiving information from a plurality of members that include real estate buyers, sellers and third party service providers;
presenting searchable requests from buyers, the buyer requests including location information, financial information, and property type;
presenting searchable listings of sellers, the seller listings including location information, financial information, and property type;
presenting searchable information of third party service providers;
receiving member requests for information of other members; and
providing requested information to a requesting member.

19. The computer readable tangible medium of claim 18, wherein the third party provider information includes at least one of a number of years of experience, a number of employees, and office locations.

20. The computer readable tangible medium of claim 18, wherein the operations further comprise:
providing a webpage that enables a seller to search buyer requests by entering search criteria, the search criteria including location, financial information and property type.
